(19) United States
(12) Patent Application Publication
(10) Pub. No.: US 2015/0126716 A1
(43) Pub. Date: May 7, 2015

(54) NITRATED LIGNIN ESTER AND PROCESS OF MAKING THE SAME

(71) Applicants: Iowa State University Research Foundation, Inc., Ames, IA (US); Siegwerk Druckfarben AG & Co. KgaA, Siegburg (DE)

(72) Inventors: Michael Richard Kessler, Pullman, WA (US); Ying Xia, Woodbury, MN (US); Benjamin Caes, West Des Moines, IA (US); Manuel J. Rivas, Clive, IA (US); James Bergman, Ames, IA (US)

(21) Appl. No.: 14/525,664

(22) Filed: Oct. 28, 2014

Related U.S. Application Data
(60) Provisional application No. 61/898,512, filed on Nov. 1, 2013.

(51) Int. Cl. C08H 7/00

(52) U.S. Cl. CPC C08H 6/00
USPC 530/505

(57) ABSTRACT

The present invention is related to a nitrated lignin ester, comprising a structure including ester groups derived from hydroxy groups of lignin, nitric acid ester groups and nitro-group substituted aromatic moieties. The present invention is furthermore related to a process of making said nitrated lignin ester.

### CLAIM OF PRIORITY

This application claims the benefit of priority of U.S. Provisional Patent Application Ser. No. 61/898,512, entitled “NITRATED LIGNIN ESTER AND PROCESS OF MAKING THE SAME,” filed on Nov. 1, 2013, the benefit of priority of which is claimed hereby, and which is incorporated by reference herein in its entirety.

### BACKGROUND OF THE INVENTION

Lignin is a biopolymer occurring in plants, such as wood. It consists of phenolic macromolecules with varying structure and is renewable. Industrially, it is obtained as a by-product of the paper-making process. By the known Kraft process (sulphate process) and/or the sulfite process, alkaline lignin or ligninsulfonates may be obtained. However, lignin and lignin derivatives have not had solubilities compatible with common solvent systems, such as alcohols and esters, limiting their use.

### SUMMARY OF THE INVENTION

According to various embodiments of the present invention, the above object has been solved by providing a novel nitrated lignin ester having improved solubility characteristics, which can be used as a renewable polymer or polymer filler.

Thus, in a first aspect the present invention is related to a nitrated lignin ester, comprising:

a lignin structure comprising
(C₂-C₁₀)ester groups derived from hydroxy groups of lignin, nitric acid ester groups, and
phenyl rings having nitro groups substituted thereon.
   Said nitrated lignin ester is preferably obtainable from lignin, more preferably alkaline lignin, by esterification and nitration.

In a further aspect, the present invention is related to a process for preparing a nitrated lignin ester, the process comprising:
a) esterifying lignin, to provide a lignin ester;
b) nitrating the lignin ester.

### BRIEF DESCRIPTION OF THE FIGURES

The drawings illustrate generally, by way of example, but not by way of limitation, various embodiments discussed in the present document.

FIG. 1 illustrates a Hansen solubility sphere for lignin starting material, in accordance with various embodiments.

FIG. 2 illustrates a Hansen solubility sphere for nitrated lignin butyrate, in accordance with various embodiments.

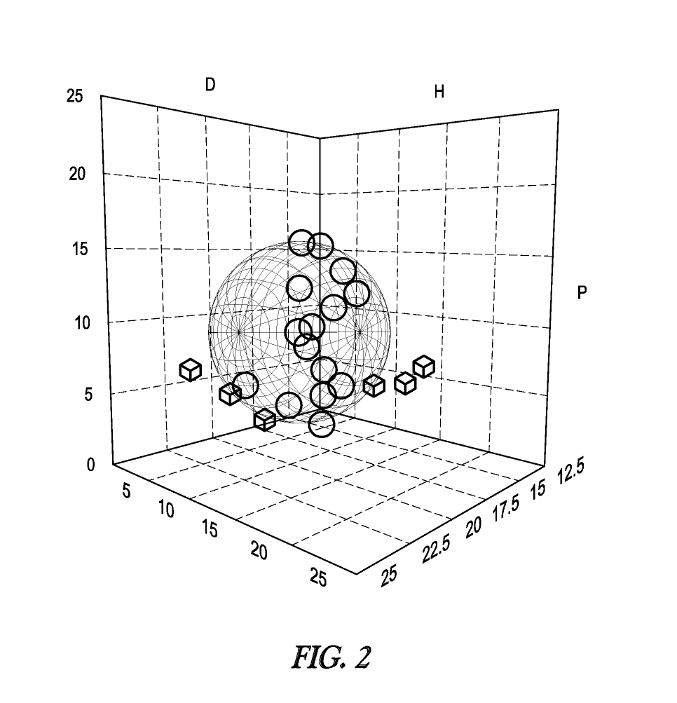

### DETAILED DESCRIPTION OF THE INVENTION

According to the present invention, the term “nitrated lignin ester” defines a product which is obtained from lignin by esterification and nitration. For example, a nitrated lignin ester according to the present invention can be obtained from alkaline lignin which is the product of the above described Kraft process. Basically, in the Kraft process lignin-containing biomaterial is treated with mineral acids without the application of heat.

A sample structure of lignin is shown below:

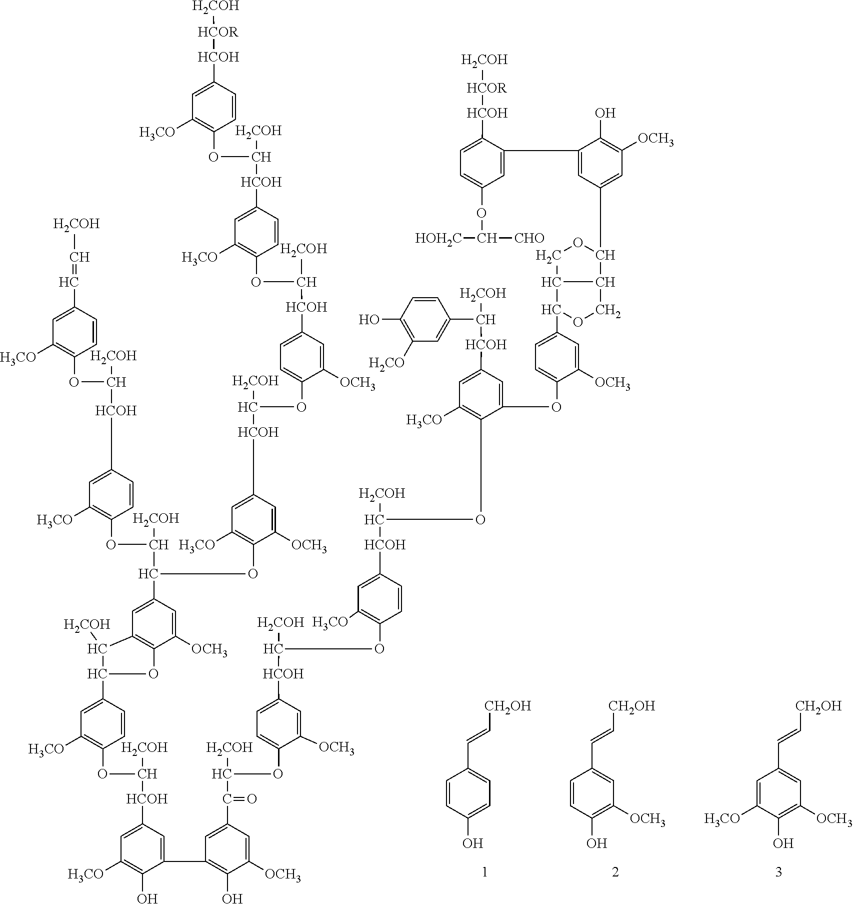

The units 1, 2 and 3 represent phenyl propane monomers that can be found in lignin: 1) p-coumaryl alcohol; 2) coniferyl alcohol; 3) syingyl alcohol.

According to the present invention, it is preferred to use an alkaline lignin which has been prepared according to the method described in WO 2007/12440 A2 (Greenvalue S.A.). The content of WO 2007/12440 A2 is incorporated herein by reference. Basically, lignin from, e.g., the above described Kraft process is subjected to a chemo-thermomechanical treatment involving mechanical shear at a maximum temperature of about 100-220° C. and a pressure of about 0.5 to 10 atmospheres in the presence of an additive such as a glycol which lowers the softening point of the lignin. Such alkaline lignins are commercially available as a dry powder under the trade name Protobind sold by ALM India.

An exemplary lignin suitable for preparing the nitrated lignin esters of the present invention is sold under the commercial name Protobind™ 2000 or Protobind™ 2400. It has a softening temperature of about 130° C., and is insoluble in an aqueous medium having a pH of 7 or less. However, it is highly soluble in an aqueous medium having a pH higher than 7. This is a big difference to conventional lignins, which are generally poorly soluble. The water solubility of the commercial products of the Protobind series varies. However, also other commercially available lignins from, for example, ALM India, Mead-Westvaco or Flambeau River paper may be used.

According to the present invention, the nitrated lignin ester is preferably obtained from lignin by esterification and subsequent nitration.

According to the present invention, any suitable esterification of lignin known from the art may be used. However, it is preferred that the lignin starting material is reacted with a respective carboxylic anhydride in stoichiometric amounts for achieving the desired degree of esterification, in the presence of a catalyst.

According to the present invention, the esterification is preferably performed using a an anhydride of a C₁₋₈ carboxylic acid, preferably an anhydride of a C₂₋₆ carboxylic acid, and most preferably acetic acid anhydride, propionic acid anhydride, or butyric acid anhydride. It should be noted, however, that esterification could also be performed using the respective carboxylic acids or carboxylic acid halogenides (e.g., acid halides), for example.

A catalyst can be used for the esterification reaction. Any catalyst conventionally used for such esterification reactions may be used for the present invention. Preferably, a metal catalyst such as zinc is used. Most preferred are zinc granules.

According to the present invention, the term “about” as used herein can allow for a degree of variability in a value or range, for example, within about 10%, within about 5%, or within about 1% of a stated value or of a stated limit of a range.

According to the present invention, the term “degree of esterification” defines the percentage of hydroxy groups present in the lignin starting material which are converted into ester groups in the course of the above esterification reaction of the present invention. According to the present invention, it is preferred that during the above described esterification reaction a degree of esterification is reached where half or the majority of hydroxyl groups of the lignin starting material, preferably about 50 to about 100%, more preferably about 70 to about 100%, of the hydroxyl groups have reacted.

The esterification reaction according to the present invention is preferably carried out in a suitable solvent, such as butyl acetate. In some embodiments, the esterification reaction can be carried out in water.

The esterification reaction can be carried out under conventionally used conditions, preferably under stirring for 2 to 24 h, preferably 2 to 10 h, at a temperature of 50 to 150° C., preferably 100 to 150° C.

The reaction product can be then purified by separating, preferably decanting, the reaction mixture from the catalyst and washing with a suitable solvent, preferably an alkane such as n-hexane. The washing step may be conducted several times in order to increase the purification.

The thus obtained lignin ester can be subjected to nitration, for example by a nitration process similar to the one described in GB-866,968. The lignin ester is suspended in an organic liquid which is inert to nitric acid at least under cooling conditions such as, e.g., 0° C. or lower, such as carbon tetrachloride (CCl₄), carbon disulphide (CS₂), methylene dichloride (CH₂Cl₂), or ethyl acetate, preferably ethyl acetate, and subsequently reacted with nitric acid (HNO₃) at a temperature not exceeding 28° C. in order to avoid oxidative degradation. Preferably, concentrated HNO₃ (“fuming” nitric acid) is used. According to the present invention, the nitration is preferably carried out under stirring for 0.5 h to 10 h, 1 h to 5 h, 1 min to 8 h, 1 min to 2 h, or 5 min to 1 h, at a temperature of −10 to +10° C., preferably −5 to +5° C. In some embodiments, the nitration of the lignin ester is carried out in an aqueous medium, such as using a nitrating agent selected from the group consisting of HNO₃ (fuming), HNO₃ (conc.), H₂SO₄ with HNO₃ (fuming), and H₂SO₄ with HNO₃ (conc). If a combination of H₂SO₄ and HNO₃ is used, in some embodiments the ratio of H₂SO₄ to HNO₃ can be 1:1 to 3:1, or 2:1 to 1:1.

According to the present invention, the term “degree of nitration” defines the percentage of the sites present in the lignin ester susceptible to nitration, to which in the course of the above nitration reaction of the present invention nitro groups are attached. Preferably, the sites in the lignin ester molecule which are susceptible to nitration are located at the aromatic ring moiety of phenolic groups of the lignin ester, preferably in meta position to a hydroxy group or an ether group, as well as free hydroxy groups in the lignin ester. According to the present invention, it is preferred that a degree of nitration in the range of about 1 to about 100%, preferably in the range of about 50 to about 100% and most preferably in the range of about 75 to about 100%, is reached.

The nitrated lignin esters of the present invention may vary in their degree of nitration and esterification and in their molecular weight. Thus, one further aspect of the present invention is related to a nitrated lignin ester as described above, characterized in that the nitrated lignin ester has a degree of esterification where half or the majority of hydroxyl groups of the lignin starting material, preferably about 50 to about 100%, more preferably about 70 to about 100%, of the hydroxyl groups have reacted, and a degree of nitration in the range of about 1 to about 100%, preferably in the range of about 50 to about 100% and most preferably in the range of about 75 to about 100%.

According to the present invention, it has been found that solubility of the nitrated lignin esters in common solvents can be improved by adjusting a specific degree of esterification and a specific degree of nitration in the nitrated lignin ester. Generally, an increased degree of esterification and an increased degree of nitration leads to improved solubility of the resulting nitrated lignin esters. Particularly preferred embodiments of the present invention are nitrated lignin esters having a degree of esterification of about 50% to about 100% in combination with a degree of nitration of about 100%, and nitrated lignin esters having a degree of esterification of about 75 to about 100% in combination with a degree of nitration of about 75%.

The degree of esterification and the degree of nitration obtained in the method of the present invention can be, for example, adjusted by varying the stoichiometric ratios of the starting materials, or by varying the reaction conditions, as known to a skilled man.

According to the present invention, it has been found that the suitability of the thus obtained nitrated lignin ester can be improved if, after the usual work-up procedure involving the removal of the solvent and washing, preferably several times, with a suitable solvent, preferably an alkane such as n-hexane, the reaction product is furthermore subjected to washing with water. Preferably, the reaction product is mixed with water and stirred for 2 to 20 h, and subsequently filtered off the water and dried.

It has been found that by means of said washing step the odor and color of the product can be reduced. By said washing steps by-products or starting materials having a distinct odor, such as butyric acid, butyric anhydride and nitric acid, as well as by-products or starting materials having a distinct color can be significantly removed from the reaction product.

It should be noted that the present invention is not limited to nitrated lignin esters which are obtained by the above method. Other methods for preparing nitrated lignin esters may also be applied. For example, nitration may also be carried out with a mixture of concentrated sulphuric acid (H₂SO₄) and concentrated nitric acid under cooling and stirring in an organic solvent. According to the present invention, any method for nitrating lignin ester is suitable which does not lead to an undesirable degree of oxidative degradation and which yields to a soluble nitrated lignin.

The nitrated lignin esters are soluble in a variety of solvents, such as acetone, methyl ethyl ketone, ethanol, or isopropanol. In particular, the nitrated lignin ester of the present invention exhibits highly improved solubility in alcohol/ester blends which are the solvent mixtures typically used in flexographic or gravure inks. Thus, the nitrated lignin esters of the present invention are very suitable as binder component in a pigmented coating.

The nitrated lignin ester of the present invention may be used as binder component in a polymer composite such as a pigmented coating, or in an overprint varnish.

It has been found that the nitrated lignin esters of the present invention have a profile of characteristics which enable them to partly or completely replace nitrocellulose.

### EXAMPLES

The present invention will now be further explained on the basis of non-limiting examples.

### Example 1

### Synthesis of Nitrated Lignin Ester

100 g sulphur-free lignin were suspended in a mixture of butyl acetate (250 ml) and butyric anhydride (140 g). Zinc pellets (20 mesh, 50 g) were added, and the reaction mixture was stirred vigorously. The reaction mixture was heated to reflux conditions at 120° C. under vigorous stirring, and kept under those conditions for 3 h. Thereafter, the reaction mixture was decanted from the zinc and transferred into a beaker, where the reaction mixture was allowed to cool to room temperature (20-25° C.), washed with hexane and dried. Lignin butyrate was obtained as a pure product.

100 g of the thus obtained lignin butyrate was dissolved in ethyl acetate (250 ml), cooled to 0° C. and stirred vigorously. To said reaction mixture, 50 ml fuming nitric acid (HNO₃) were added dropwise. After complete addition of the nitric acid, the reaction mixture was stirred at 0° C. for a further 3 h. Thereafter, the reaction mixture was poured into a beaker, and ethyl acetate was removed by applying a stream of compressed air for 1 h. The resulting reaction mixture was washed with hexane, thereby recovering nitrated lignin butyrate. The nitrated lignin butyrate was put into water and stirred overnight (12 h) to remove any residual acid. The product was then separated from the water and dried, thus yielding nitrated lignin butyrate.

The degree of esterification and nitration was determined by elemental analysis. Elemental analysis results (% C, % H, % N) were acquired using a PE 2100 Series II combustion analyzer (Perkin Elmer Inc.). The elemental analysis gave the following result: 57.71% C, 4.95% H, 3.48% N.

In addition, the product was evaluated using FT-IR analysis (Fourier transformation infrared analysis). The degree of esterification was additionally evaluated using ³¹P NMR analysis. Here, the amount of remaining unreacted hydroxyl groups was evaluated as follows: a solvent mixture of 7.2 ml pyridine and 4.0 ml deuterated chloroform was prepared. A mixture solution of 25 mg cyclohexanol (internal standard), 18 mg chromium acetylacetone (relaxing agent) and 5.0 ml of solvent mixture was prepared. The ³¹P NMR was then performed on a mixture of 25 mg lignin, 0.400 ml solvent solution, 0.150 ml mixture solution, and 0.070 ml 2-chloro-1,3,2-dioxaphospholane (phosphorylating agent). The NMR was collected at room temperature with a 25 second delay between scans, 64 scans in total. The lignin starting material had a hydroxyl content of ˜3.7 mmol/g. The nitrated lignin ester obtained in said example had a hydroxyl content of about 0.3-0.6 mmol/g.

### Example 2

The solubility of nitrated lignin butyrate was compared with the solubility of the lignin starting material (Protobind™ 2400). The evaluation was performed by comparing Hansen solubility parameters. Hansen solubility parameters and their determination are known in the art (e.g. C. Hansen (ed.), Hansen Solubility parameters—A user's guide, CRC Press, Boca Raton, 2^{nd} ed. 2007, in particular chapter I, the respective content is incorporated herein by reference). Hansen solubility parameters were estimated by the solubility of each lignin in 25 solvents, listed in Table 1. The solubility was scored as “1” for completely soluble, “2” for partially soluble, and “3” for insoluble. The solubilities were the input for the Hansen Solubility Parameter in Practice software (http://hansen-solubility.com/index.html) which computed a Hansen solubility sphere for each lignin.

TABLE 1

| Solvent | δ_{D} | δ_{P} | δ_{H} |
|---|---|---|---|
| Acetic Anhydride | 16.0 | 11.7 | 10.2 |
| Acetone | 15.5 | 10.4 | 7.0 |
| Acetonitrile | 15.3 | 18.0 | 6.1 |
| 1-Butanol | 16.0 | 5.7 | 15.8 |
| Butyl Acetate | 15.8 | 3.7 | 6.3 |
| Butyric Acid | 15.7 | 4.8 | 12.0 |
| Chloroform | 17.8 | 3.1 | 5.7 |
| Cyclohexane | 16.8 | 0.0 | 0.2 |
| Diethyl Ether | 14.5 | 2.9 | 4.6 |
| Dimethyl Formamide (DMF) | 17.4 | 13.7 | 11.3 |
| Dimethyl Sulfoxide (DMSO) | 18.4 | 16.4 | 10.2 |
| 1,4-Dioxane | 17.5 | 1.8 | 9.0 |
| Ethanol | 15.8 | 8.8 | 19.4 |
| Ethyl Acetate | 15.8 | 5.3 | 7.2 |
| Heptane | 15.3 | 0.0 | 0.0 |
| Hexane | 14.9 | 0.0 | 0.0 |
| Methanol | 14.7 | 12.3 | 22.3 |
| Methyl Ethyl Ketone (MEK) | 16.0 | 9.0 | 5.1 |
| Methylene Dichloride | 17.0 | 7.3 | 7.1 |
| 1-Propanol | 16.0 | 6.8 | 17.4 |
| 2-Propanol | 15.8 | 6.1 | 16.4 |
| Propyl Acetate | 15.3 | 4.3 | 7.6 |
| Styrene | 18.6 | 1.0 | 4.1 |
| Tetrahydrofuran (THF) | 16.8 | 5.7 | 8.0 |
| Toluene | 18.0 | 1.4 | 2.0 |

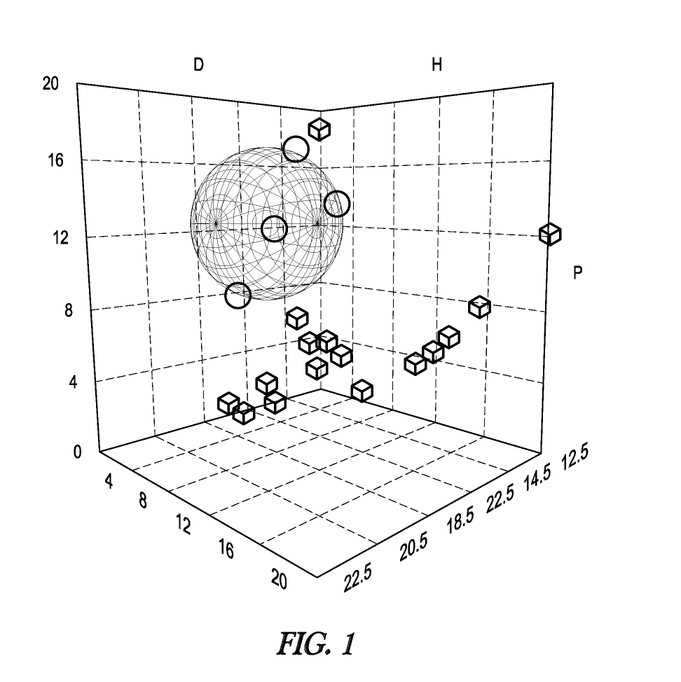

The Hansen solubility sphere for lignin starting material and nitrated lignin butyrate (100% esterification and 100% nitration) computed with Practice software are shown in FIGS. 1 (lignin) and 2 (lignin butyrate, 100% nitration, 100% esterification). The Hansen Solubility Parameter in Practice software produced a mesh 3-D representation of the solubility sphere for each lignin in space defined by the Hansen solubility parameters. The small spheres represent good solvents (e.g., included in the solubility sphere). The small cubes represent poor solvents (e.g., not included in the solubility sphere).

TABLE 2
Hansen solubility parameters

| | δ_{D} | δ_{P} | δ_{H} | radius |
|---|---|---|---|---|
| lignin | 17.6 | 9.9 | 5.5 | 9.3 |
| lignin butyrate, 100% nitration, | 18.2 | 9.1 | 8.1 | 7.6 |
| 100% esterification | | | | |

Increased degree of nitration and butyration increased the solubility in tested solvents. Whereas for the lignin starting material only 4 good solvents were determined, in the case of lignin butyrate (100% nitration, 100% esterification) 11 good solvents were determined.

### Example 3

The un-nitrated lignin ester generated in Example 1 was put into a reaction vessel. Then the nitrating agent (aqueous solution of fuming nitric acid and water) was added. 15 parts by weight of the aqueous solution of the nitrating agent were used per 1 part by weight of lignin ester. The resulting mixture was stirred and reacted for a period of about 30 minutes. Subsequently, the aqueous acid solution was removed from the solid product by filtration, and the solid product was washed with water to remove residual acid. The solid product was then dried.

What is claimed is:

1. A nitrated lignin ester, comprising:
a lignin structure comprising
(C₂-C₁₀)ester groups derived from hydroxy groups of lignin, nitric acid ester groups, and
phenyl rings having nitro groups substituted thereon.

2. The nitrated lignin ester according to claim 1, wherein said nitrated lignin ester is derived from lignin by esterification and nitration.

3. The nitrated lignin ester according to claim 1, wherein said nitrated lignin ester is derived from alkaline lignin.

4. The nitrated lignin ester according to claim 1, wherein said nitrated lignin ester has a degree of esterification wherein half or the majority of hydroxyl groups of the lignin starting material are esterified, and a degree of nitration of about 1% to about 100%.

5. The nitrated lignin ester according to claim 4, wherein said nitrated lignin ester has a degree of esterification wherein about 50% to about 100% of the hydroxyl groups are esterified.

6. The nitrated lignin ester according to claim 4, wherein said nitrated lignin ester has a degree of esterification wherein about 70% to about 100% of the hydroxyl groups are esterified.

7. The nitrated lignin ester according to claim 4, wherein the nitrated lignin ester has a degree of nitration of about 50% to about 100%.

8. The nitrated lignin ester according to claim 4, wherein the nitrated lignin ester has a degree of nitration of about 75% to about 100%.

9. The nitrated lignin ester according to claim 1, wherein said nitrated lignin ester has a degree of esterification of about 50% to about 100% in combination with a degree of nitration of about 100%.

10. The nitrated lignin ester according to claim 1, wherein said nitrated lignin ester has a degree of esterification of about 75% to about 100% in combination with a degree of nitration of about 75%.

11. The nitrated lignin ester according to claim 1, wherein the (C₂-C₁₀)ester groups of said nitrated lignin ester are independently chosen from acetate, propionate, and butyrate.

12. A process for preparing a nitrated lignin ester, the process comprising:
a) esterifying lignin, to provide a lignin ester;
b) nitrating the lignin ester.

13. The process according to claim 12, wherein alkaline lignin is used as starting material.

14. The process according to claim 13, wherein the alkaline lignin is obtainable by subjecting lignin to a chemo-thermo-mechanical treatment comprising mechanical shear at a maximum temperature of about 100-220° C. and a pressure of about 0.5 to about 10 atmospheres in the presence of an additive which lowers the softening point of the lignin.

15. The process according to claim 14, wherein the additive comprises a glycol.

16. The process according to claim 12, wherein the nitration is performed with concentrated HNO₃ in an ester solvent.

17. The process according to claim 16, wherein the ester solvent is an acetic ester.

18. The process according to claim 12, wherein the nitration reaction product is washed with water sufficiently to reduce the odor and color of the product.
